(19) United States
(12) Patent Application Publication
(10) Pub. No.: US 2026/0118733 A1
(43) Pub. Date: Apr. 30, 2026

(54) HIGH-BANDWIDTH PHOTONIC MEMORY WITH A WARM ATOMIC VAPOR

(71) Applicant: Qunnect, Inc., Brooklyn, NY (US)

(72) Inventors: Yang Wang, New York, NY (US); Mehdi Namazi, Brooklyn, NY (US); Alexander Craddock, Brooklyn, NY (US); Mael Flament, Brooklyn, NY (US); Felipe Giraldo Mejia, New York, NY (US); Jaeda Mackayla Mendoza, Brooklyn, NY (US)

(73) Assignee: Qunnect, Inc., Brooklyn, NY (US)

(21) Appl. No.: 19/151,246

(22) PCT Filed: Feb. 9, 2024
(86) PCT No.: PCT/US2024/015193

§ 371 Date: Jul. 25, 2025

Related U.S. Application Data
(60) Provisional application No. 63/484,446, filed on Feb. 10, 2023.

(51) Int. Cl. G02F 1/35; B82Y 10/00; B82Y 20/00; G02F 1/01; G02F 1/39; G04F 5/14; G06N 10/40

(52) U.S. Cl. CPC G02F 1/3503; B82Y 10/00; B82Y 20/00; G02F 1/0115; G02F 1/392; G04F 5/14; G06N 10/40; G02F 2203/15; G02F 2203/26

(57) ABSTRACT

Techniques for facilitation the storage and retrieval of the qubits in a hot atomic vapor system are described herein. The techniques comprising, transmitting a first control pulse having a bandwidth that is based on a bandwidth of the optical qubit to modify transmission properties of the atomic vapor system: receiving the optical qubit at the atomic vapor system; transmitting a second control pulse having properties based on a target bandwidth for a retrieved optical qubit to modify transmission properties of the atomic vapor system; and isolating the retrieved optical qubit from the control laser.

### CROSS REFERENCE TO RELATED APPLICATIONS

This application claims the benefit of priority under 35 U.S.C. § 119(e) to U.S. Provisional Patent Application Ser. No. “63/484,446”, filed on Feb. 10, 2023, and entitled “HIGH-BANDWIDTH PHOTONIC MEMORY WITH A WARM ATOMIC VAPOR,” Attorney Docket No. Q0074.70013US00 which is incorporated by reference herein in its entirety.

### BACKGROUND

Quantum networks facilitate the transmission of information in the form of quantum bits (“qubits”) between physically separated quantum processors or other quantum devices (e.g., quantum sensors). Quantum networks may be used to enable optical quantum communication over distances and can be implemented over standard telecommunication optical fibers through the transmission of single photons onto which information is encoded (e.g., in polarization). To enable the reliable transmission of quantum information over any distance, additional components may be needed.

### SUMMARY

The following is a non-limiting summary of some embodiments of the present application. Some embodiments provide for a method for improving a bandwidth of optical qubits stored in an atomic vapor, the method comprising: preparing a control laser pulse to store an optical qubit using a hot atomic vapor system, the optical qubit having a bandwidth, wherein preparing the control laser pulse comprises: generating the control laser pulse having a bandwidth based on a temporal profile of the optical qubit; and adjusting a pulse energy of the control laser pulse based on the temporal profile of the optical qubit; transmitting the control laser pulse through the hot atomic vapor system to modify transmission properties of the atomic vapor; and receiving the optical qubit at the hot atomic vapor system during the transmission of the control laser pulse through the hot atomic vapor system.

In some embodiments, adjusting the bandwidth of the control laser pulse based on the temporal profile of the optical qubit comprises modulating a source of the control laser pulse to adjust the bandwidth of the control laser pulse.

In some embodiments, a fiber-coupled electro-optical modulator is used to modulate the source of the control laser pulse.

In some embodiments, the bandwidth of the control laser pulse is adjusted to have approximately a same temporal profile as the optical qubit.

In some embodiments, adjusting a pulse energy of the control laser pulse is further based on properties of the atomic vapor and a beam geometry of the control laser pulse.

In some embodiments, adjusting the amplification of the pulse such that the pulse intensity of the control laser pulse at the atomic vapor results in a transparency window having a linewidth approximately the same as the bandwidth of the optical qubit.

In some embodiments, adjusting the pulse energy of the control laser pulse comprises amplification of the control laser pulse after adjusting the bandwidth of the control laser pulse.

In some embodiments, the atomic vapor comprises a Rubidium atomic vapor.

In some embodiments, transmitting the control laser pulse through the hot atomic vapor system modifies a three-level system of the Rubidium atomic vapor producing a transparency window.

In some embodiments, the transparency window has a bandwidth between 10 and 100 GHz.

Some embodiments provide for a method for controlling a bandwidth of optical qubits retrieved from an atomic vapor storage, the method comprising: determining a target bandwidth for a retrieved optical qubit; preparing a control laser to retrieve a stored optical qubit from a hot atomic vapor system such that the retrieved optical qubit has the target bandwidth; transmitting the control laser through the hot atomic vapor system to modify transmission properties of the hot atomic vapor system; receiving the retrieved optical qubit form the hot atomic vapor system in response to the control laser; and isolating the retrieved optical qubit from the control laser.

In some embodiments, the control laser is prepared to produce the retrieved optical qubit having a same bandwidth as the previously stored optical qubit.

In some embodiments, the control laser is prepared to produce the retrieved optical qubit having a different bandwidth than the previously stored optical qubit.

In some embodiments, the target bandwidth of the retrieved optical qubit being based on a bandwidth of a second optical qubit, such as to improve an interference generated by interfering the retrieved optical qubit with the second optical qubit.

In some embodiments, preparing the control laser to retrieve the stored optical qubit from the hot atomic vapor system, such that the retrieved optical qubit has the target bandwidth, comprises modulating the control laser using a fiber-mounted electro-optic modulator.

In some embodiments, preparing the control laser to retrieve the stored optical qubit from the hot atomic vapor system, such that the retrieved optical qubit has the target bandwidth, comprises modulating the control laser using an acousto optic modulator.

In some embodiments, the atomic vapor comprises a Rubidium atomic vapor.

In some embodiments, transmitting the laser control pulse through the hot atomic vapor system modifies a three-level system of the Rubidium atomic vapor producing a transparency window.

Some embodiments provide for a system for improving storage and retrieval of optical qubits stored in an atomic vapor, the system comprising: a hot atomic vapor system comprising an atomic vapor; a control laser configured to: transmit a first control pulse having a bandwidth that is based on a bandwidth of an optical qubit to modify transmission properties of the hot atomic vapor system; and transmit a second control pulse having properties based on a target bandwidth for a retrieved optical qubit; and an optical filtering system configured to isolate the retrieved optical qubit from the control laser, the optical filtering system comprising: a first etalon configured in a first double pass configuration, the first etalon having a first bandwidth; and a second etalon configured in a second double pass configuration, the second etalon being positioned to receive an output of the first etalon, and the second etalon having a second bandwidth, wherein the second bandwidth is different from the first bandwidth.

In some embodiments, the first etalon receives light output from the hot atomic vapor system, and the first etalon is configured with a first polarizing beam splitter such that light returning from a double pass through the first etalon and a waveplate is directed to the second etalon; and the second etalon is configured with a second polarizing beam splitter such that light returning from a double pass through the second etalon is directed to a detector.

### BRIEF DESCRIPTION OF DRAWINGS

FIG. 1 illustrates a quantum memory module 100, in accordance with some embodiments of the technology described herein.

FIG. 2 illustrates an example of an optical qubit storage process 200, in accordance with some embodiments of the technology described herein.

FIG. 3 illustrates an example of an optical qubit storage process 300, in accordance with some embodiments of the technology described herein.

FIG. 4 illustrates an example of an optical qubit retrieval process 400, in accordance with some embodiments of the technology described herein.

FIG. 5A illustrates an example of an absorption spectrum 500 corresponding to the EIT regime, in the low-bandwidth limit.

FIG. 5B illustrates an example of an absorption spectrum 504 corresponding to the ATS regime, in the high-bandwidth limit.

FIG. 6A illustrates the EIT window as the transmission of a weak probe field through a room-temperature vapor under different control field strengths, in accordance with some embodiments of the technology described herein.

FIG. 6B illustrates temporal traces of the retrieved photons retrieved in a memory operation using different optical powers of the control fields, in accordance with some embodiments of the technology described herein.

FIG. 7A illustrates plot 700 of input time profile 702 and output time profile 704, in accordance with some embodiments of the technology described herein.

FIG. 7B illustrates plot 710 of input time profile 712 and output time profile 714, in accordance with some embodiments of the technology described herein.

FIG. 7C illustrates plot 720 of a varied input pulse duration and the corresponding FWHM of the retrieved qubits, in accordance with some embodiments of the technology described herein.

FIG. 8 illustrates an example of a control pulse generation module 800, in accordance with some embodiments of the technology described herein.

FIG. 9 illustrates an example of a memory unit 900, in accordance with some embodiments of the technology described herein.

FIG. 10 illustrates an example of filter unit 1000, in accordance with some embodiments of the technology described herein.

FIG. 11 illustrates an example of an optical filter configuration 1100 for filtering the control laser from the retrieved qubit, in accordance with some embodiments of the technology described herein.

FIG. 12 illustrates an acoustic-optic modulator-based configuration 1200 for modulating the bandwidth of a laser to generate a control pulse, in accordance with some embodiments of the technology described herein.

FIG. 13A illustrates the acousto-optic modulation performance for an 80 MHz shift and focused beam, in accordance with some embodiments of the technology described herein.

FIG. 13B illustrates the memory performance using the AOM setup from FIG. 13A, in accordance with some embodiments of the technology described herein.

FIG. 14 illustrates a direct electro-optic modulator configuration 1400 for controlling the control laser, in accordance with some embodiments of the technology described herein.

FIG. 15A illustrates the electro-optic modulation performance, in accordance with some embodiments of the technology described herein.

FIG. 15B illustrates the memory performance using the EOM setup from FIG. 15A, in accordance with some embodiments of the technology described herein.

FIG. 16 illustrates a low power EOM phase switching configuration 1600 with optical amplification, in accordance with some embodiments of the technology described herein.

FIG. 17A illustrates the RF pulse recorded by the photodiode, in accordance with some embodiments of the technology described herein.

FIG. 17B illustrates the Fourier transform of the pulse show in FIG. 17A.

FIG. 18 illustrates the photon bandwidth as a function of control field power, in accordance with some embodiments of the technology described herein.

FIG. 19 illustrates an example of a lower power EOM intensity switching configuration 1900 with optical amplification, in accordance with some embodiments of the technology described herein.

FIG. 20 illustrates an example of a pulse generated using an intensity modulator and TA, in accordance with some embodiments of the technology described herein.

FIG. 21A is an example of the memory fidelity in the high-bandwidth regime, using fEOM with phase modulation and TA amplification, in accordance with some embodiments of the technology described herein.

FIG. 21B illustrates an example plot of the bandwidth of a qubit retrieval process, in accordance with some embodiments of the technology described herein.

### DETAILED DESCRIPTION

The inventors have developed techniques to facilitate quantum information science by improving the storage and retrieval of qubits. The techniques include methods and systems for adjusting the bandwidth of control pulses for use in qubit storage within a hot atomic gas.

Quantum repeaters have been proposed as solutions to overcome transmission loss for adapting the expansive existing telecommunications fiber infrastructure for use in a quantum network. In a quantum repeater, one divides a long communications channel into many elementary links and uses pair-wise entanglement swapping to distribute entanglement between the two remote parties. For most common quantum repeater schemes, a quantum memory is a core enabling device that allows single photons to be temporarily stored in a long-lived matter state and retrieved on-demand, enabling the storage of entanglement across elementary links. As the entanglement process is probabilistic, the use of quantum mechanics provides an improvement in implementing entanglement swapping and significantly increases the entanglement distribution rate, serving as a foundation for global-scale quantum networks.

Quantum memories are devices capable of storing and retrieving photonic qubits on-demand. This functionality can be characterized by three parameters: fidelity, F, which describes the degradation of the input quantum state of the photons; storage efficiency, n, defined as the probability of storing and retrieving photons; and storage time, T, which assesses the time it takes for the storage efficiency to decay significantly. For a quantum memory in a quantum network, these parameters jointly determine the entanglement distribution rate and scaling over distances and can therefore be used to describe the “quantum performance” of the quantum memory.

For implementation into existing telecommunication infrastructure, further metrics apply: fiber-hub compatibility, which prefers devices low in size, weight, and power consumption (SWaP); robustness against environmental noises (e.g., electromagnetic, thermal, mechanical); and scalability for mass deployment. These parameters can be used to describe the “hardware performance” of a quantum memory. A field-deployable quantum memory serving a large-scale quantum network should satisfy both sets of criteria for quantum and hardware performance.

Quantum memories with high levels of quantum performance have been realized in different physical systems, including ensembles of atoms or ions, rare-earth-doped crystals, defects in diamonds, and quantum dots. However, the supporting technologies required to achieve high quantum performance from these systems are resource-intensive and include cryogenic cooling systems, ultrahigh vacuum systems, and sophisticated laser cooled trapping systems. The requirements of each of these systems, including requirements such as energy use, space requirements, cryogen use, and vibration isolation, are prohibitive to the deployment of these quantum memories in the field and in large-scale quantum networks.

The inventors have recognized and appreciated that warm atomic vapor systems are a promising platform for implementing a quantum memory with improved quantum and hardware performance because warm atomic vapor systems are a simple and robust physical platform that operate at, or above, room temperature (e.g., in a range from 18° C. to 25° C. or higher, without the need for cryogens or vacuum technologies. For example, one realization utilizes an ensemble of room-temperature atoms with an internal three-level structure in the lambda configuration. A strong external laser field (termed “control” field), specifically its electric field, modifies the properties of the three-level atoms interacting with the photon to be stored (termed “probe” field), which is known as the “electromagnetic induced transparency” (EIT) phenomenon. This mechanism allows signal photons to be mapped to a long-lived matter state and recalled by turning off and on the control field.

The three-level atoms largely determine the wavelength of the light pulses that can be stored; the frequency difference between the intrinsic energy difference and the light field is called detuning, D. The excited-state lifetime is a natural choice for benchmarking bandwidth, and we call it G. The memory protocol can operate within a large detuning range. For the case where D>>G, it is usually called the Raman protocol, and for D<G, it is called EIT. Despite proposed differences in the mechanics of the underlying physics, both regimes may be experimentally treated as the same process and well described by a unified theory. A nonlimiting explanation is described in Yisheng Lei, Faczch Kimiace Asadi, Tian Zhong, Alex Kuzmich, Christoph Simon, and Mahdi Hosseini, “Quantum optical memory for entanglement distribution,” Optica 10, 1511-1528 (2023), which is hereby incorporated by reference herein in its entirety. Therefore, regardless of the underlying physics—whether occurring via the Raman protocol or the EIT phenomenon—the light field modifies the transmission properties of the three-level atomic system.

The inventors have recognized that for optimal storage, the spectral properties of the atomic medium should match the photon to be stored. A transform-limited pulse has a bandwidth, B, defined as the full width at half-maximum (FWHM) of its spectral peak. In the EIT regime, the transparency peak has a width AoErr determined by the control field strength (Ω_{c}). By adjusting the power of the control field under the same conditions, the transparency window can be changed, such that photons with bandwidth B˜Δω_{EIT} can be optimally stored.

The inventors have further recognized that for photonic-based quantum communication applications, bandwidth plays an important role. Accordingly, the inventors have developed physical systems to control the bandwidth in photonic quantum communication systems. To store photons with low bandwidth (temporally long), e.g., <1 MHz, the power of the control field may be decreased to reduce the EIT window size. However, to store photons with a high bandwidth (temporally short), e.g., >100 MHz, both increases to the power of the control field and matching of the bandwidth of the control pulse to the bandwidth of the photons to be stored may be required to optimize the storage and retrieval. The inventors have further realized that due to technical limitations regarding the switching on and off of the control field, including the finite time required to complete a switching operation, it may be challenging to control the bandwidth of the control pulse for storage/retrieval operations. The bandwidth of the switching can be characterized by measuring the 10%-90% rise/fall time. As an alternative to the use of switches to turn the laser on and off in a binary fashion, the storage/retrieval can be implemented by pulsing the control field, in which case, the FWHM of the pulse represents the switching bandwidth. In both cases, one must ensure the switching bandwidth is comparable to or larger than the photon bandwidth B. Failing to maintain such a matching between the bandwidths may deteriorate the storage efficiency due to bandwidth mismatch. Therefore, high-bandwidth storage may be limited by the control field (or its Rabi frequency (Ω_{c}) and its temporal bandwidth to be comparable to the photon to be stored. For example, to store a photon with ˜100 MHz bandwidth, a control field with 200 mW and ˜3 ns duration is required for typical beam sizes and Rb atoms.

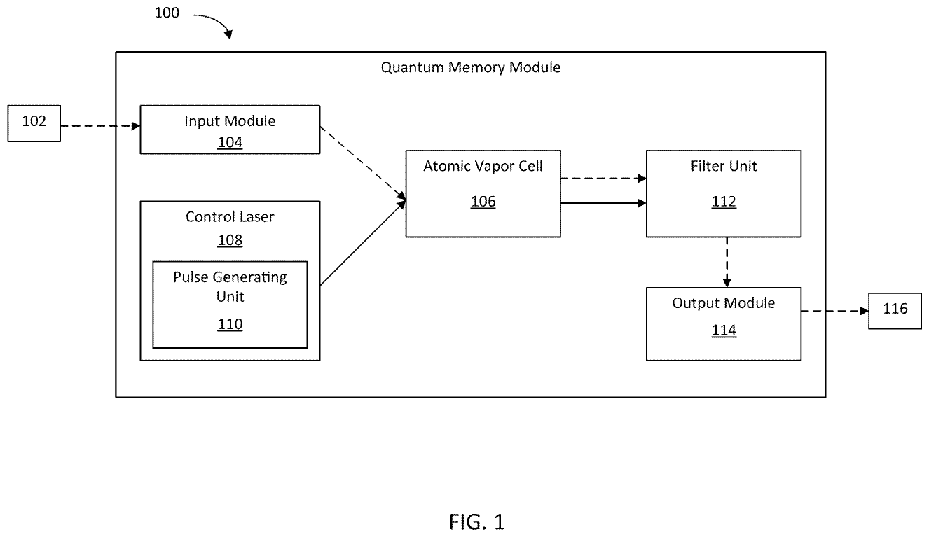

FIG. 1 illustrates a quantum memory module 100, in accordance with some embodiments of the technology described herein. Quantum memory module 100 receives qubit 102 through input module 104. The received qubit is stored in atomic vapor cell 106 such that the qubit may be retrieved after a temporal delay. Following retrieval, the retrieved qubit 116 is transmitted from quantum memory module 100 through output module 114.

Input module 104 includes optical components to facilitate receiving and directing an optical qubit to atomic vapor cell 106. Optical components to facilitate receiving an optical qubit may include free space optical components and/or fiber-optic optical components. In some embodiments, the input module 104 receives an optical qubit from an optical qubit source. For example, input module 104 may receive an optical qubit from an entanglement source.

The storage and retrieval of the qubit within atomic vapor cell 106 is controlled by control laser 108. Upon retrieval of the qubit using the control laser, the control laser light and the retrieved qubit propagate along a shared optical path. Accordingly, a filter unit 112 is configured to filter the control laser such that the retrieved qubit may be transmitted from the quantum memory module 100 for use and/or detection.

Output module 114 includes optical components to facilitate receiving a retrieved qubit from filter unit 112 and directing the retrieved qubit 116 out of quantum memory module 100. In some embodiments, output module 114 may direct the retrieved qubit into a detector. In some embodiments, the output module 114 may direct the retrieved qubit to a destination for quantum communication. For example, the output module 114 may direct the retrieved qubit into a fiber for transmitting over long distances to a quantum communication detector.

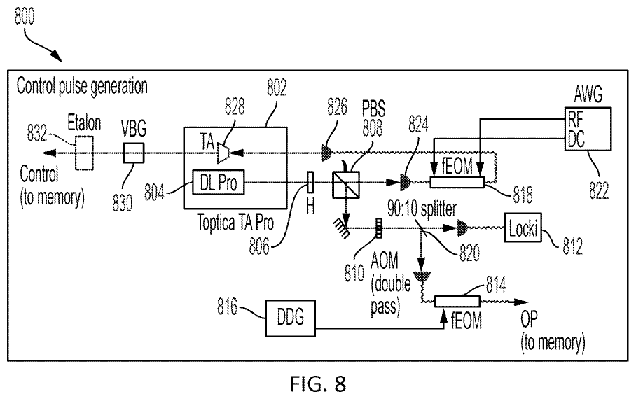

Control laser 108 generates a control beam(s) to facilitate the storage and retrieval of optical qubits in atomic vapor cell 106. In some embodiments, control laser 108 includes a pulse generating unit 110 for generating control laser pulses, the pulse generating unit may be implemented in any suitable way including the designs described herein in connection with FIGS. 8-21B.

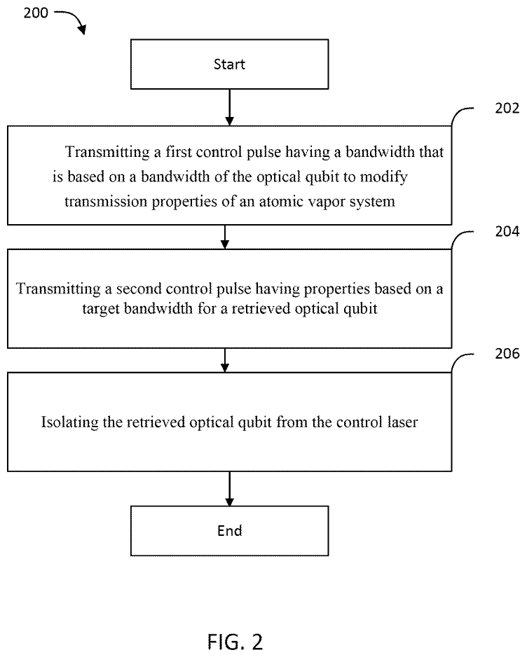

FIG. 2 illustrates an example of an optical qubit storage process 200, in accordance with some embodiments of the technology described herein.

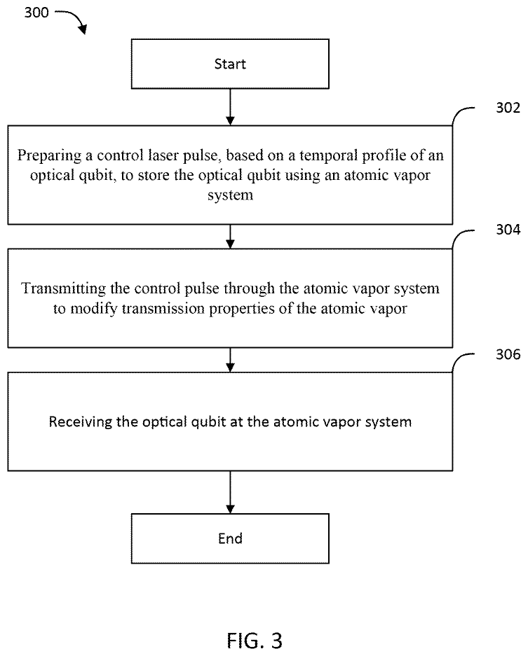

Process 200 starts at act 202, by transmitting a first control pulse having a bandwidth that is based on a bandwidth of the optical qubit to modify transmission properties of an atomic vapor system, in accordance with some embodiments of the technology described herein. Act 202 may be implemented using process 300, described below in connection with FIG. 3.

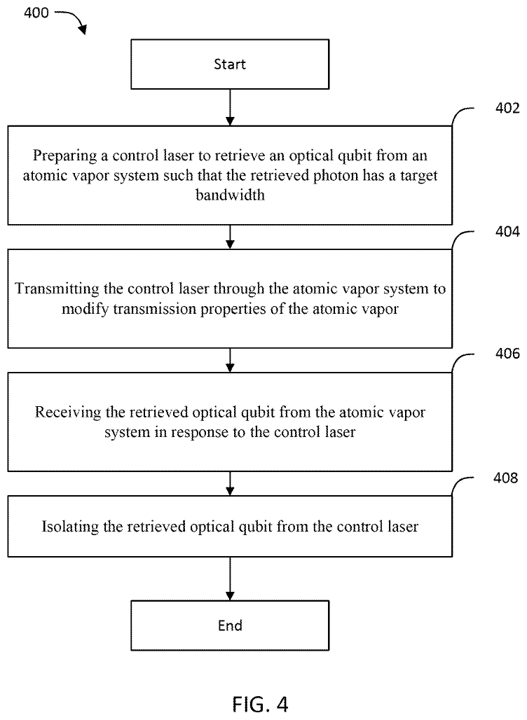

Next, process 200 proceeds to act 204, by transmitting a second control pulse having properties based on a target bandwidth for a retrieved optical qubit, in accordance with some embodiments of the technology described herein. Act 204 may be implemented in accordance with process 400, described below in connection with FIG. 4.

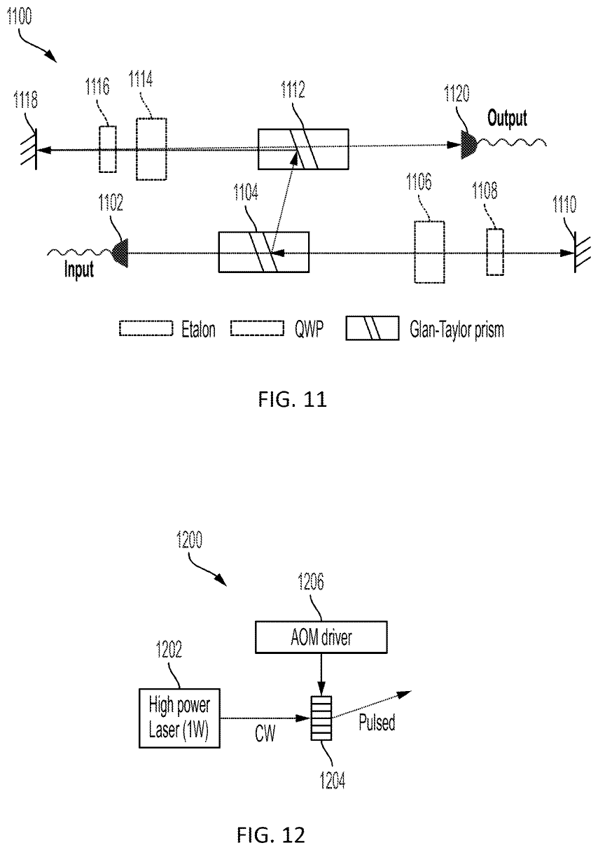

Next, process 200 proceeds to act 206, by isolating the retrieved optical qubit from the control laser, in accordance with some embodiments of the technology described herein. Isolating the retrieve optical qubit from the control laser may be achieved using any suitable filter, as described herein, including the filters described in connection with FIGS. 10 and 11. Following act 206, process 200 concludes.

FIG. 3 illustrates an example of an optical qubit storage process 300, in accordance with some embodiments of the technology described herein.

Process 300 starts at act 302 by preparing a control laser pulse, based on a temporal profile of an optical qubit to store an optical qubit using an atomic vapor system, in accordance with some embodiments of the technology described herein. As described above, the effectiveness of a storage operation (e.g., the ability to retrieve a qubit having a high signal to noise) depends at least in part on the temporal profile of the optical qubit. Accordingly, preparing the control laser pulse includes generating the control laser pulse having optical properties to facilitate storage of the qubit. The optical properties of the control laser pulse may include bandwidth of the control laser pulse, pulse energy of the control laser pulse, and center frequency of the control laser pulse.

In some embodiments, preparing the control laser pulse includes generating the control laser pulse having a bandwidth based on the temporal profile of the optical qubit. The control laser pulse bandwidth may be generated to have approximately the same temporal profile as the optical qubit. The temporal profile of the qubit may be measured as the temporal bandwidth as measured by the full width at half maximum (FWHM) of the qubit's duration relative to its intensity. For example, approximately the same temporal profile may be the control laser pulse having a FWHM within ±1%, ±2%, ±5%, ±10%, or ±15% of the FWHM of the optical qubit.

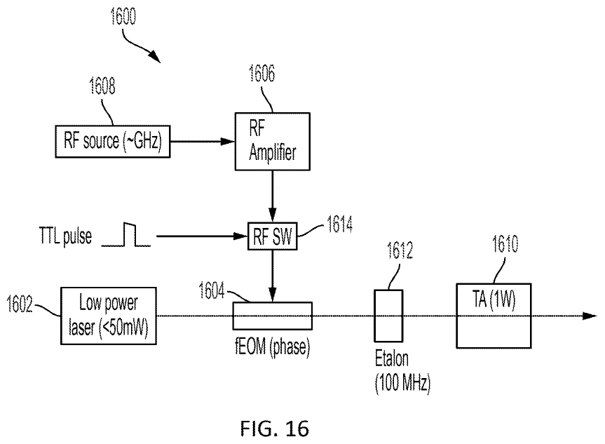

In some embodiments, generating the laser pulse bandwidth to have approximately the same temporal profile as the optical qubit includes using a fiber-coupled electro-optical modulator to modulate the source of the control laser pulse. As described further in connection with FIGS. 16-21B below. In some embodiments, generating the laser pulse bandwidth to have approximately the same temporal profile as the optical qubit includes using an acoustic optic modulator or an electro optic modulator, as described further in connection with FIGS. 12-15 below.

As the energy levels of the atomic gas system depend upon the composition of the atomic gas, the frequency and bandwidth of the control laser pulse may be generated based on the frequencies of the respective energy levels of the three-level system of the atomic gas system. For example, the control laser pulses may be generated based on a desired detuning, D, between the laser and energy levels of the lambda atomic system.

In some embodiments, preparing the control laser pulse includes generating the control laser pulse having a Rabi frequency based on the temporal profile of the optical qubit. The Rabi Frequency is described by Equation 1 below.

$${Ω}_{c} = μ E / h \qquad Equation 1$$

In Equation 1, shown above, u is the transition dipole moment of the atom or molecule, E is the electric field strength of the laser, and h is Planks constant. As the Rabi frequency depends on the electric field strength, the Rabi frequency may be adjusted by adjusting the pulse energy of the control laser pulse. The control laser pulse energy may be adjusted to have a Rabi frequency approximately the same as the bandwidth of the optical qubit. For example, the Rabi frequency being approximately the same as the bandwidth of the optical qubit may be when the Rabi frequency is within ±1%, ±2%, ±5%, ±10%, or ±15% of the bandwidth of the optical qubit.

In some embodiments, adjusting a pulse energy of the control laser pulse based on the temporal profile of the optical qubit includes adjusting the gain of an amplifier to increase or decrease the pulse energy of the control laser pulse. In some embodiments, adjusting a pulse energy of the control laser pulse based on the temporal profile of the optical qubit includes adjusting attenuation of the control laser pulse to decrease the intensity of the control laser pulse.

In some embodiments, adjusting a pulse energy of the control laser pulse is based on the atomic gas system. The composition of the atomic gas system may change the rabi frequency of the system as the control laser pulse is transmitted through the atomic gas. For example, the dipole moment of the atomic gas impacts the rabi frequency as described in equation 1 above. Accordingly, adjusting the pulse energy of the control laser pulse is based on the properties of the atomic gas. For example, the atomic gas system may be an atomic vapor include a vapor of ⁸⁷Rb atoms.

In some embodiments, preparing the control laser pulse includes adjusting the pulse energy at least in part based on the beam geometry. The intensity of the light depends on the pulse energy and the beam size. Accordingly, preparing the control laser pulse includes adjusting the pulse energy based on the beam size at the atomic gas such that the control laser pulse has a target intensity to produce the desired rabi frequency at the atomic gas.

In some embodiments, generating the control laser pulse having a bandwidth based on the temporal profile of the optical qubit includes generating the control laser pulse prior to amplification of the pulse. After generating the control pulse having the bandwidth based on the temporal profile of the optical qubit, the pulse energy of the control laser pulse is adjusted.

In some embodiments, generating the control laser pulse having a bandwidth based on the temporal profile of the optical qubit includes adjusting the bandwidth of the seed pulse (e.g., the pulse that is sent into an optical amplifier) such that upon amplification, the amplified pulse has the desired bandwidth based on the temporal profile of the optical qubit. Following amplification, the pulse energy may be adjusted through attenuation.

In some embodiments, the bandwidth of the control laser pulse may be adjusted after amplification of a seed pulse. The bandwidth of the amplified control laser pulse may be adjusted through nonlinear optical process. For example, an optical parametric amplifier may be used to adjust the pulse bandwidth. As another example, a nonlinear optical parametric amplifier may be used to adjust the pulse bandwidth. In some embodiments, another nonlinear optical process may be used to adjust the bandwidth, as aspects of the technology described herein are not limited in this respect.

In some embodiments, compression optics may be used to compress the temporal bandwidth of the control laser pulse. For example, chirped mirrors may be used to compress the temporal bandwidth of the control laser pulse. In some embodiments, optical components may be used to increase the dispersion of an optical pulse, expanding the temporal bandwidth of the control laser pulse.

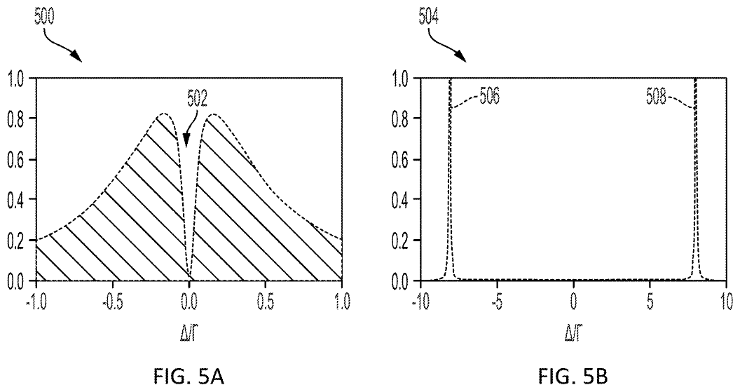

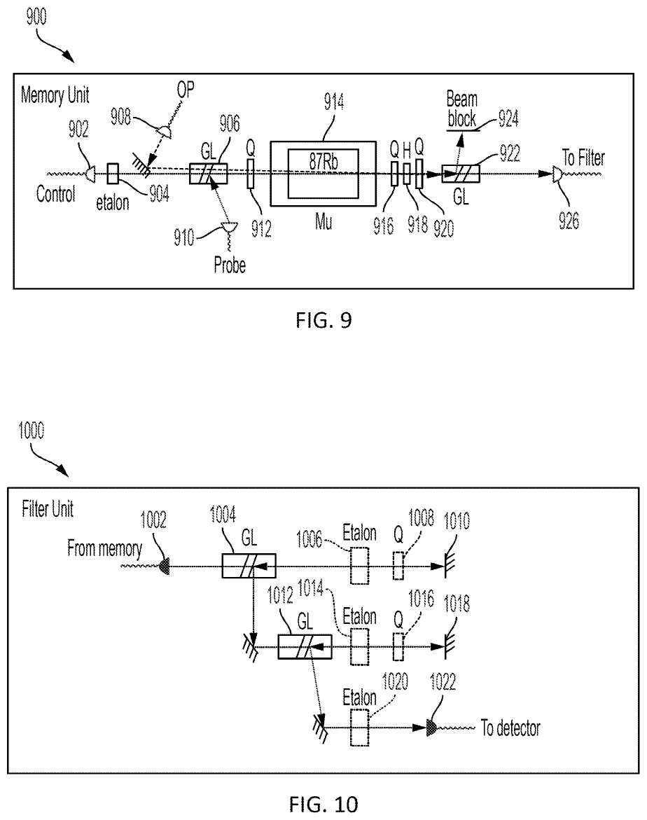

Next, process 300 continues to act 304 by transmitting the control laser pulse through the atomic vapor system to modify transmission properties of the atomic vapor, in accordance with some embodiments of the technology described herein. The control laser pulse is transmitted through the atomic vapor system to modify the transmission properties of the atomic vapor, such that a transparency window is produced, as shown below in connection with FIGS. 5A and 5B. The control laser pulse is transmitted through the atomic vapor system such that the transparency window is produced during a time period when the system expects to receive an optical qubit. An example configuration of components for transmitting the control laser pulse through the atomic vapor system is included below in connection with memory unit 900 described in FIG. 9.

Next, process 300 continues to act 306 by receiving the optical qubit at the atomic vapor system, in accordance with some embodiments of the technology described herein. The atomic vapor system being a warm atomic vapor system. To store the optical qubit using the atomic vapor system, the optical qubit is received at the atomic vapor system while the control laser pulse is being transmitted through the atomic vapor system.

In some embodiments, the atomic vapor system is a rubidium (Rb) atomic vapor. For example the atomic vapor system includes a ⁸⁷Rb atomic vapor. In some embodiments, other atomic vapor systems may be used, as aspects of the technology described herein are not limited in this respect.

In some embodiments, the optical qubit is a polarization qubit. A polarization qubit includes quantum information encoded in an arbitrary polarization state of the photon. Accordingly, for effective storage of the polarization qubit, the arbitrary polarization state of the photon is retrievable from the atomic vapor system. In some embodiments, the optical qubit is a spatial qubit.

In some embodiments, a warm atomic vapor system is a room temperature atomic vapor system (e.g., 20° C.). In some embodiments, a warm atomic vapor system is between 20° C. and 40° C. In some embodiments, a warm atomic vapor system is between 18° C. to 25° C. In some embodiments, a warm vapor system is between 45° C. and 65° C. In some embodiments, a warm atomic vapor system is between 18° C. and 40° C. In some embodiments, a warm vapor system is between 10° C. and 100° C. In some embodiments, a warm atomic vapor system is between 0° C. and 100° C. In some embodiments, a warm atomic vapor system may be hotter than 40° C., as aspects of the technology described herein are not limited in this respect. As an example, the warm atomic vapor may be operated at approximately 50° C. to 60° C.

Following act 306, process 300 concludes. Following the conclusion of process 300 for storing a qubit, a qubit retrieval process may be used to retrieve the qubit from the atomic vapor. In some embodiments, the qubit retrieval process may be process 400, described below in connection with FIG. 4. In some embodiments, other retrieval processes may be used in combination with the optical qubit storage process 300, as aspects of the technology described herein are not limited in this respect.

The inventors have appreciated that a non-limiting example to explain the storage of the received optical qubit is that the control laser pulse maps the optical qubit to a collection atomic excitation. For example, the control laser pulse may map the arbitrary polarization of the optical qubit to a spin wave excitation in the atomic vapor. Accordingly, for retrieval, a control field is applied to convert the spin wave into a photon having the same arbitrary polarization as the stored photon. The retrieved photon can have a different bandwidth than the stored photon. The bandwidth of the retrieved photon being determined by the control field power.

The inventors have recognized that the bandwidth of a retrieved qubit may depend on the properties of the control field used to facilitate retrieval of the qubit from an atomic vapor where it has been stored. The inventors have further recognized that for interfering qubits in a quantum communication network, matching the bandwidths between the pulses may provide better signal to noise for subsequent detection and analysis. Accordingly, controlling of the bandwidth for a retrieved qubit may enable the matching between optical qubits produced from different sources, improving quantum communication methods. Therefore, the inventors have developed methods for controlling the bandwidth of retrieved qubits.

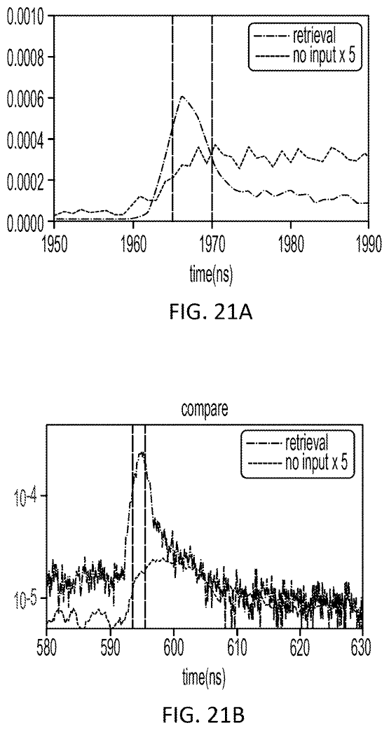

FIG. 4 illustrates an example of an optical qubit retrieval process 400, in accordance with some embodiments of the technology described herein. Prior to the start of process 400, an optical qubit may be stored in the warm atomic vapor system using an optical qubit storage process, such as process 300 described above. In some embodiments, process 400 may include determining a target bandwidth for a retrieved optical qubit. Determining the target bandwidth includes determining a temporal profile for the retrieved optical qubit. In some embodiments, the target bandwidth may be based on optimizing a signal to noise of the retrieved qubit. An example of the noise profile and the target bandwidth are discussed further in connection with FIGS. 21A and 21B below.

In some embodiments, the target bandwidth may be based on the bandwidth of a second optical qubit to optimize the signal to noise of the interference between the retrieved qubit and the second qubit. For example, the target bandwidth may be a spatial-temporal mode selected to effectively interfere with a second qubit to generate projection-based entanglement.

Process 400 starts at act 402 by preparing a control laser to retrieve an optical qubit from an atomic vapor system such that the retrieved photon has the target bandwidth, in accordance with some embodiments of the technology described herein. The target bandwidth is the target temporal profile for the retrieved photon. Preparing the control laser includes generating laser control light based on the target bandwidth. In some embodiments, the laser control light is a laser control pulse. The laser control pulse may be generated to have approximately the same bandwidth as the target temporal profile of the retrieved qubit. In some embodiments, the laser control pulse is generated and/or adjusted as described in connection with FIG. 3 above.

In some embodiments, a pseudo continuous-wave control laser may be used. The pseudo continuous-wave control laser uses a continuous-wave (CW) laser modulated such that the light field provided to the atomic vapor system is turned on and off (e.g., pulsed). For example, a CW laser may be pulsed using a fEOM driven by a fast digital delay generator (DDG), as described herein.

Next, process 400 continues to act 404 by transmitting the control laser through the atomic vapor system to modify transmission properties of the atomic vapor, in accordance with some embodiments of the technology described herein. The control laser is transmitted through the atomic vapor system to modify the transmission properties of the atomic vapor, such that a transparency window is produced, as described below in connection with FIGS. 5A and 5B. The control laser is transmitted through the atomic vapor system such that the transparency window is produced and the qubit received. An example configuration of components for transmitting the control laser pulse through the atomic vapor system is included below in connection with FIGS. 8 and 9.

Next, process 400 continues to act 406 by receiving the retrieved optical qubit from the atomic vapor system in response to the control laser, in accordance with some embodiments of the technology described herein. The atomic vapor system being a warm atomic vapor system. The retrieved optical qubit is received following transmission of the control laser.

Next, process 400 continues to act 408 by isolating the retrieved optical qubit from the control laser, in accordance with some embodiments of the technology described herein. Following retrieval of the optical qubit, the retrieved qubit and the control laser may be copropagating. Accordingly, prior to detecting, interfering, and/or processing the retrieved optical qubit, the qubit is isolated from the control laser. In some embodiments, the retrieved optical qubit is isolated using multiple dual pass etalons, as described herein in connection with FIGS. 10 and 11. In some embodiments, other isolation techniques may be used, as aspects of the technology described herein are not limited in this respect.

Following act 406, process 400 concludes. Following the conclusion of process 400, the retrieved qubit may be detected. Detection may include detecting the qubit using polarizing beam splitters and one or more single photon detectors. In some embodiments, detection may include interfering the retrieve qubit and interfering the retrieved qubit with a second qubit.

With regard to the transparency window produced by the control laser, there are two regimes which scale differently relative to the rabi frequency 22c. The first regime, the EIT regime, corresponds to the low-bandwidth limit. The low-bandwidth limit may be considered when the bandwidth is smaller than the excited state lifetime, G. In the EIT regime, the bandwidth scales with the power of the control field: ΔΩ_{EIT}˜Ω_{c}². FIG. 5A illustrates an example of an absorption spectrum 500 corresponding to the EIT regime. In the EIT regime, the transparency window is characterized by the FWHM of the absorption dip. The absorption dip is shown as dip 502 in absorption spectrum 500.

The second regime, the “Autler-Townes splitting” (ATS) regime, corresponds to a high-bandwidth limit. The high-bandwidth limit may be considered to be when the bandwidth is larger than the excited state lifetime, G. In the ATS regime, the bandwidth scaling changes to Δω˜Ω_{c}. FIG. 5B illustrates an example of an absorption spectrum 504 corresponding to the ATS regime, in the high-bandwidth limit. In the ATS regime, the transparency window is the separation between two absorption peaks 506 and 508, as shown in absorption spectrum 504.

In an implemented atomic vapor system for memory storage, the difference between ATS and EIT may not be detectable experimentally. Accordingly, either regime may be used depending on the target bandwidth for storage, in accordance with some embodiments of the technology described herein.

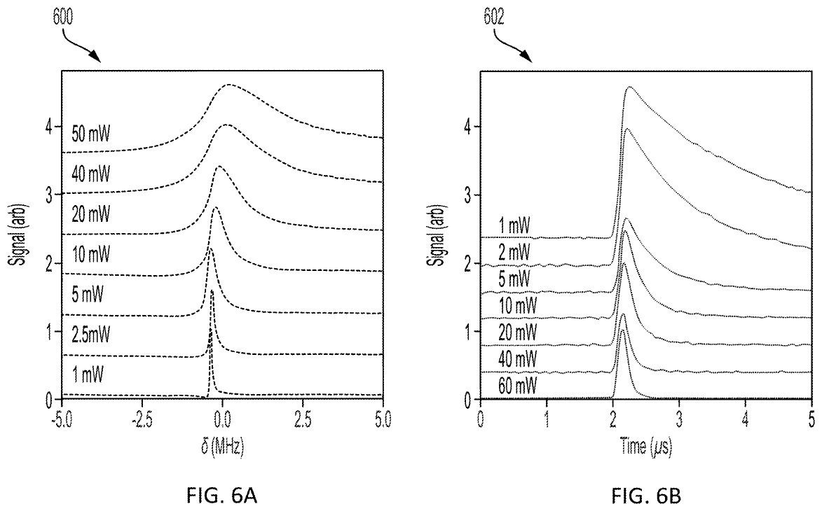

As described above, the pulse energy of the control laser may be adjusted based on a bandwidth of the optical qubit for storage, or the retrieved optical qubit for retrieval. The relationship between the pulse energy (e.g., power) with both the transparency window and the retrieved photon bandwidth is illustrated by FIGS. 6A and 6B. FIGS. 6A and 6B show the transparency window and the retrieved photon bandwidth increase in size with increasing control power field.

FIG. 6A illustrates the EIT window as the transmission of a weak probe field through a room-temperature vapor under different control field strengths, in accordance with some embodiments of the technology described herein. The plot 600 shows the normalized transmission of a probe field (having a power of approximately 5 μW) for different control field powers and as a function of two-photon detuning, δ. Traces for FIG. 6A are offset vertically.

FIG. 6B illustrates temporal traces of the retrieved photons retrieved in a memory operation using different optical powers of the control fields, in accordance with some embodiments of the technology described herein. Although illustrated for the EIT regime, a similar phenomenon would be observed in the Raman regime. As shown in plot 602, the temporal profiles represent bandwidths of photons retrieved at different control field powers of the control laser. Traces for FIG. 6B are offset vertically.

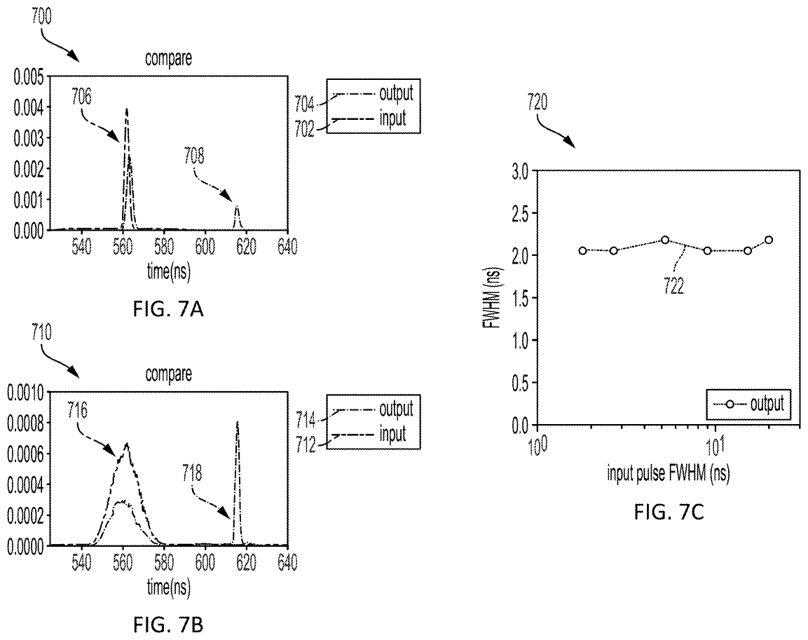

The inventors have recognized and appreciated that based on the dependence of the retrieved qubit bandwidth on the control laser, the input qubit (e.g., stored qubit) and the output qubit (e.g., the retrieved qubit) can have different bandwidth characteristics. Accordingly, the memory serves as a bandwidth converter. FIGS. 7A, 7 B, and 7C illustrate the difference in bandwidth characteristics of input qubits and output qubits and the efficacy of the control laser to maintain a consistent output bandwidth characteristic across input qubits.

FIG. 7A illustrates plot 700 of input time profile 702 and output time profile 704. Input time profile 702 includes peak 706 corresponding to an input qubit. Output time profile 704 includes peak 708 corresponding to an output qubit.

FIG. 7B illustrates plot 710 of input time profile 712 and output time profile 714. Input time profile 712 includes peak 716 corresponding to an input qubit. Output time profile 714 includes peak 718 corresponding to an output qubit. As illustrated through the comparison of FIGS. 7A and 7B, although the input qubits are drastically different, the same control field is used to retrieve the qubits. Accordingly, as reflected in FIGS. 7A and 7B, the retrieved qubits 708 and 718 have similar bandwidths.

FIG. 7C illustrates plot 720 of a varied input pulse duration and the corresponding FWHM of the retrieved qubits, in accordance with some embodiments of the technology described herein. As shown in plot 720 by curve 722, the input pulse duration is varied over more than one order of magnitude but the control laser for retrieval is kept approximately constant. Accordingly, despite the variability of the input pulse, the output pulse FWHM remains approximately constant. Although illustrated as varying the input qubit and producing a constant output qubit bandwidth, in some embodiments, the opposite implementation may be used. For example, a constant input bandwidth may be used, and the output bandwidth may be varied by varying the control laser for retrieval.

FIG. 8 illustrates an example of a control pulse generation module 800, in accordance with some embodiments of the technology described herein. Control pulse generation module 800 includes laser source 802. Laser source 802 include diode laser 804. The diode laser generates continuous wave laser light. Half waveplate 806 and polarizing beam splitter 808 split the output from diode laser 804. A first portion of the continuous wave laser light enters fiber 824 where it is modulated by fEOM 818 according to a modulation signal generated by arbitrary waveform generator (AWG) 822. The modulated light exits the fiber at end 826 and is amplified by tapered amplifier (TA) 828. The amplified light passes through variable Bragg grating 830 and etalon 832 before being sent to the memory module to be used as a control pulse for a storage process, in accordance with some embodiments of the technology described herein.

A second portion of the continuous wave laser light is sent through an AOM prior to being split by a 90:10 splitter 820. One output of the 90:10 splitter includes lock-in detector 812, the second output is sent into a fiber for modulation by fEOM 814 driven by a digital delay generator (DDG) 816. The resulting pulse may be a pseudo continuous wave pulse used for a memory retrieval process, in accordance with some embodiments of the technology described herein. In some embodiments, laser source 802 is a Toptica TA Pro amplified laser. In some embodiments, another amplified laser system may be used as aspects of the technology described herein are not limited in this respect.

FIG. 9 illustrates an example of a memory unit 900, in accordance with some embodiments of the technology described herein. Memory unit 900 receives a control laser pulse to facilitate a qubit storage process from a control pulse generation module, such as control pulse generation module 800 shown in FIG. 8, through optical fiber 902. The control pulse passes through etalon 904, Glan-Laser prism 906, quarter waveplate 912, before entering atomic vapor system 914. Glan-Laser prism 906 combines control laser pulses and an incoming qubit into a shared optical path such that both the control laser pulses and the incoming qubit are directed into the atomic vapor system 914. The control laser pulse induces a change in the transmission properties of the atomic vapor to facilitate storage of a qubit in the atomic vapor. Memory unit 900 receives a qubit from fiber optic 910 for storage in atomic vapor system 914. The qubit passes through Glan-laser prism 906 and quarter waveplate 912 before passing into vapor storage system 914. Memory unit 908 receives a control pulse to facilitate a retrieval process from fiber optic 908. Following the vapor storage system 914, control laser pulses and retrieved qubits pass through quarter waveplate 916, half waveplate 918, quarter waveplate 920, and Glan-laser prism 922. The Glan-laser prism 922 directs control light to beam block 914 and directs the retrieved qubit to filter system 926.

Although illustrated as a single beam configuration, a dual beam configuration may be used such as the dual beam configuration described in #.

The inventors have recognized and appreciated that an ideal filter should have a bandwidth greater than the highest photon bandwidth the memory is designed to operate with. At the same time, the filters should provide enough suppression of the strong control laser to achieve high SNR and fidelity. Accordingly, the inventors have developed a multi-double-pass filter that uses two etalons each with a different bandwidth to filter the control laser while preserving the bandwidth.

FIG. 10 illustrates an example of filter unit 1000, in accordance with some embodiments of the technology described herein. Filter unit 1000 receives input light from memory unit through fiber optic 1002. The input light including a retrieved qubit and residual laser light from the control laser pulse. The input light passes through a Glan-laser polarizer 1104 configured to separate orthogonal polarizations of light. Etalon 1006 is configured in a dual pass configuration with quarter waveplate 1008 and retroreflector 1010. Accordingly, the input light passes through etalon 1006 traveling towards quarter waveplate 1008 and then is reflected by retroreflector 1010. Following reflection by retroreflector 1010, the input light undergoes a second pass through quarter waveplate 1008 before a second pass through etalon 1006. Having acquired a phase shift from the two passes through quarter waveplate 1009, the Glan-laser prism 1004 directs input light towards second Glan-laser prism 1012. Glan-laser prism 1012 receives the input light from the first Glan-laser prism 1004 such that the input light passes through Glan-laser prism 1012 to etalon 1014. Etalon 1014 is configured in a dual pass configuration with quarter waveplate 1016 and retroreflector 1018. Accordingly, the input light passes through etalon 1014 traveling towards quarter waveplate 1016 and retroreflector 1018 and then is reflected by retroreflector 1018. Following reflection by retroreflector 1018, the input light undergoes a second pass through quarter waveplate 1016 before a second pass through etalon 1014. Having acquired a second phase shift from the two passes through quarter waveplate 1016, the Glan-laser prism 1012 directs the now filtered light towards detector 1022. In some embodiments, a third single pass etalon 1020 may be included in the optical path between Glan-laser prism 1012 and detector 1022.

FIG. 11 illustrates an example of an optical filter configuration 1100 for filtering the control laser from the retrieved qubit, in accordance with some embodiments of the technology described herein. Optical filter configuration 1100 includes input 1102, Glan-Taylor prisms 1104 and 1112, etalons 1106 and 1114, quarter waveplates 1108 and 1116, retroreflectors 1110 and 1118, and output 1120. Input 1102 receives input light including a retrieved qubit and control laser light from an atomic vapor system. The input light pass through Glan-Taylor prism 1104 to etalon 1106. Following etalon 1106, the filtered light passes through quarter waveplate 1108 to retroreflector 1110, and back through quarter waveplate 1108 for a second pass through etalon 1106. Following the second pass through etalon 1106 and having acquired a phase shift from the two passes through the quarter waveplate, the input light is directed from Glan-Taylor prism 1104 to Glan-Taylor prism 1112. Glan-Taylor prism 1112 directs the input light towards etalon 1114. After a first pass through etalon 1114, the light passes through quarter wave plate 1116 before being reflected by a retroreflector 1118 for a second pass through quarter wave plate 1116 and etalon 1114. Following the second pass through etalon 1114, the light is now filtered light. The filtered light passes through Glan-Taylor prism 1112 to output 1120.

In some embodiments, etalons 1106 and 1114 are flat etalons. In some embodiments, etalon 1106 has a free spectral range of 15 GHz and etalon 1114 has a free spectral range of 30 GHz. In some embodiments, etalons 1106 and 1114 provide 120 dB suppression and 50% transmission. The light passes through each etalon twice by retro-reflecting itself with a mirror and QWP to avoid interference. The retro-reflecting also guarantees that the two passes hit the same surface area, so they share the same resonance conditions (temperature dependent). A Glan-Taylor prism (instead of PBS) is used such that the etalon-rejected light does not couple back to the filtered light path. This single-rail setup can be easily expanded to a dual-rail by introducing a Sagnac-like interferometer that has been developed before. The dual rail can still fit through the rest of the optical elements easily.

For high-bandwidth memory operations depend on two conditions: 1) high control field strength (e.g., (Ω_{c}) for opening a transparency window; and 2) high bandwidth control of such fields (to maximize the efficiency). To provide high control field strengths, laser amplifier technologies may be used. For example, high control field strengths can be achieved using solid-state tapered amplifiers (TAs). TAs may deliver serval Watts of power, which in combination with a focused beam (approximately 1 mm diameter) may provide Rabi frequencies in the range of 100 MHz. To provide high bandwidth control, while maintaining high control field strengths the inventors have developed several configurations to operate over different bandwidth ranges. Accordingly, depending on the properties of the photon to be stored, (e.g., whether the qubit originates from a narrowband source such as a Rydberg atom or a broadband source such as a SPDC) the appropriate configuration may be used.

FIG. 12 illustrates an acoustic-optic modulator-based configuration 1200 for modulating the bandwidth of a laser to generate a control pulse, in accordance with some embodiments of the technology described herein. Acoustic-optic modulators (AOMs) use the acousto-optical effect to diffract and frequency-shift light with a traveling sound wave at an RF frequency generated by a piezo transducer. By modulating the RF power (and frequency), the intensity of the diffracted light can be adjusted. For example, the speed of sound in a TeO₂ crystal is approximately 4,260 m/s. When used to diffract light to generate a laser pulse, the cross-section of the light will determine the bandwidth of the switching. The damage threshold for an AOM is generally high, relative to other methods, as the diffraction occurs inside the bulk material of the crystal. Therefore, an AOM can handle high laser power (e.g., a Watt) directly. Acoustic-optic modulator-based configuration 1200 includes high-power laser 1202, acousto-optic crystal 1204, and acousto-optical driver 1206. The high-power laser 1202 generates a high-power continuous wave output that enters acousto-optic crystal 1204. The acoustic-optical driver 1206 provides the RF source to drive the acousto-optical effect at acousto-optic crystal 1204 to modulate the continuous wave light to produce pulsed light.

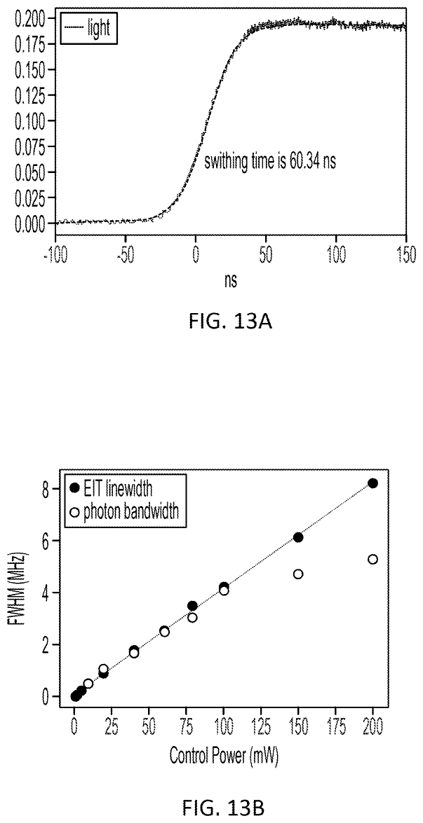

FIG. 13A illustrates the acousto-optic modulation performance for an 80 MHz shift and focused beam, in accordance with some embodiments of the technology described herein. The switching time being measured as the 10-90% time of the intensity. As shown in FIG. 13A, a switching time of approximately 60 ns is produced for an 80 MHz AOM with a 50 μm focal size.

Among commercially available AOM materials, TeO₂ has the highest speed of sound. The bandwidth of pulses using a TeO₂ crystal depend on the beam cross-section. However, when using gaussian beams, the divergence is inversely proportional to the focal size, such that there is a practical limit on how small the light can be focused. For example, when the beam divergence is comparable to the diffraction angle (which scales with RF frequency), interference between the unshifted light and the shifting light can result, causing unintended power modulation.

FIG. 13B illustrates the memory performance using the AOM setup from FIG. 13A, in accordance with some embodiments of the technology described herein. The memory performance for the AOM setup from FIG. 13A is shown for different optical powers. The EIT linewidth is measured using CW light and gives guidance on the highest bandwidth one can expect for each optical power. The divergence between the photon bandwidth and the EIT linewidth is due to the finite switching time of the AOM. Based on FIG. 13B, the suitable bandwidth of memory operation using direct AOM switching is between 0-5 MHz.

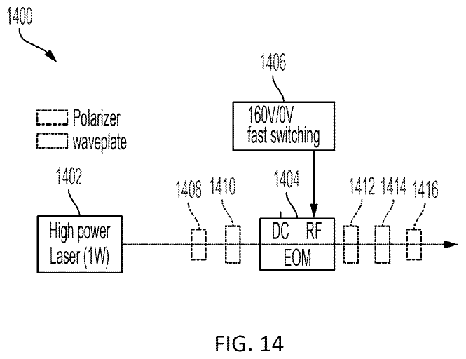

FIG. 14 illustrates a direct electro-optic modulator configuration 1400 for controlling the control laser, in accordance with some embodiments of the technology described herein. Electro-optic modulators (EOMs) rely on nonlinear optical materials where the refractive index is a function of the local electric field. Light traveling through the nonlinear optical material will acquire a phase determined by the index of refraction (e.g., the effective speed of light in the material). Accordingly, a time-varying electric field, applied to the nonlinear optical material, is used to modulate the phase of light traveling through the crystal. In some embodiments, a free-space modulator based on bulk material EOM is used. In some embodiments, a waveguide modulator is used. In some embodiments, other kinds of EOMs may be used, as aspects of the technology described herein are not limited in this respect. Direct electro-optic modulator configuration 1400 includes high power laser 1402, Pockels cell 1404, EOM driver 1406, polarizers 1408 and 1406, and waveplates 1410, 1412, and 1414.

High power laser 1402 produces laser light which passes through polarizer 1408 and then waveplate 1410 prior to traveling through Pockels cell 1404. Pockels cell 1404 receives a driving RF signal from EOM driver 1406. The Pockels cell modulates the phase of the laser light. The phase modulation of the laser light is converted to intensity modulation through waveplates 1412 and 1414 in combination with polarizer 1416.

Free space modulators rely on the Pockels electro-optic effect (e.g., Pockels cells). In Pockels cells, the electric field is applied along the direction of light propagation and can be viewed as voltage-controlled waveplates. The voltage required to reach a π-phase shift is called halfwave voltage V_{π}. For commercial products, V_{π} is generally in the range of several hundred volts to kilovolts. The π-phase can be converted to intensity modulation with polarizers and additional waveplates as shown in FIG. 14. Thereby the light intensity may be modulated by applying an electric filed. The high optical damages threshold of bulk materials allows for direct high power light field modulation.

Relative to AOM, the bandwidth of Pockels cell switching is mostly limited by the bandwidth of the driver electronics-since the speed of the electric field traveling in the crystal is typically a fraction of the speed of light, c. Pockels cells behave like a capacitors. Accordingly substantial voltage is required to achieve full modulation. To handle the high current and operate at high speeds, special circuitry is included with the EOM configuration. Off-the-shelf commercial drivers deliver a few MHz bandwidths for kV applications. In some embodiments, EOM driver 1404 is based on Gallium Nitride (GaN) field effect transistors (FET) in a buck-converter configuration. For example, EOM driver 1404 can output either 0V or 160V a fast-switching time, which is closed to the V_{π} of the Pockel cells. Accordingly, a low-voltage TTL signal may be used to trigger the switching of the EOM driver. In some embodiments, the EOM driver 1404 may use evaluation board model EPC9099 to perform the switching of the EOM driver. In some embodiments, other suitable EOM drivers, capable of providing sufficiently fast driving of the nonlinear optical material may be used, as aspect of the technology described herein are not limited in this respect.

In some embodiments, Pockels cell 1404 is a conoptics M360-40 Pockels cell. In some embodiments, other Pockels cells may be used as aspects of the technology described herein are not limited in this respect.

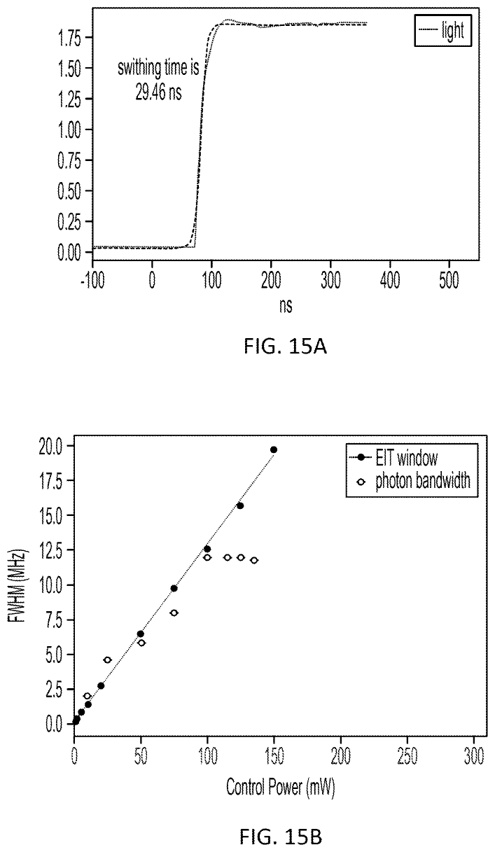

FIG. 15A illustrates the electro-optic modulation performance, in accordance with some embodiments of the technology described herein. The performance corresponds to the configuration described in connection with FIG. 14. The switching time, as measured from the 10%-90% switching time of the light field is approximately 29 ns.

FIG. 15B illustrates the memory performance using the EOM setup from FIG. 15A, in accordance with some embodiments of the technology described herein. The memory performance for the EOM setup from FIG. 15A is shown for different optical powers. The divergence between the EIT window and photon bandwidth indicates a suitable bandwidth of memory operation around between 0 and 12.5 MHz.

FIG. 16 illustrates a low power EOM phase switching configuration 1600 with optical amplification, in accordance with some embodiments of the technology described herein. EOMs on waveguides may be used to avoid the use of demanding electronics driving requirements and to provide larger switching bandwidths. EOMs on waveguides may be implemented packaged in fiber-coupled configurations (fEOM). With the smaller electric field confinement provided by the fiber, larger field strengths may be obtained with smaller input voltages. For example, Vx may be approximately 2-3V. Accordingly, the options for driving electronics is expanded relative to the EOM described in connection with FIG. 14.

Low power EOM phase switching configuration 1600 includes a low power laser 1602, fEOM 1604 for phase modulation, RF source 1608, RF amplifier 1606 RF switch 1614, TA 1610, and etalon 1612. RF source 1608 generates an RF signal which is amplified by RF amplifier 1606. The amplifier RF signal is passed through a fast RF switch 1614 that is triggered by an TTL pulse. The output from RF switch 1614 drives fEOM 1604. fEOM 1604 modulates the phase of low power laser light (e.g., less than 50 mW) received from low power laser 1602. The output of the fEOM is filtered using etalon 1612 prior to being amplified by TA 1610. In some embodiments, etalon 1612 has a 100 MHz bandwidth. In other embodiments, the etalon has other bandwidths based on the bandwidths attainable from the use of RF switch 1614.

In some embodiments, intensity modulator fEOMs are used. In some embodiments, phase modulator fEOMs are used. Phase modulator fEOMs imprint a modulating phase from the electric field to the light field. The imprinted phase generates RF sidebands to the monochromatic laser field. Passive frequency-selection elements, such as optical cavities (e.g., etalons) may be used to filter the light with the frequency of a certain sideband and reject the rest of the laser field. The intensity of the resulting sideband may be modulated by modulating the RF field.

The low voltage compatibility provides for increased hardware compatibility relative to EOM techniques. Off-the-shelf RF amplifiers can deliver approximately 30-36 dBm power for RF frequencies up to a few GHz which exceeds Va. To maximize the switching bandwidth, an active RF switch is placed after the RF amplifier. For example, a voltage variable attenuator (VVA) may be placed after the RF amplifier. In some embodiments, a ADF5020 RF switch is used which provides a few nanosecond switching capability of high-power RF field. In this configuration, the resulting bandwidth is approximately 100 MHz. Relative to bulk EOMs, fEOMs are limited in the optical power they can support due to the photorefractive effect, which is more pronounced for photons with long wavelengths (e.g., NIR photons). Accordingly, many fEOMs are limited to input powers of approximately 30 mW. After insertion loss and 30% modulation efficiency, the output power is approximately 3 mW. At this power amplification the power is insufficient for broadband operation. Optical amplifiers, such as TAs are highly nonlinear devices. Accordingly, noise generated during RF switching has the risk of introducing large noise fluctuations and even damage to the equipment. Therefore, RF switching with excitation greater than 60 dB should be used to ensure the field is truly zero when it is deemed so. Similarly, optical sideband suppression is critical to prevent amplification of the carrier field. In some embodiments, etalons may be used for optical sideband suppression. Employing a high-finesse cavity may be insufficient since it could lower the bandwidth of the passing photon. Therefore, for high bandwidth, etalon(s) that are matched to the photon bandwidth and have sufficient suppression, such as >40 dB of unwanted frequency components, are used.

Typical fEOMs have a response time down to 0.2 ns (e.g., with a 10 GHZ modulation bandwidth). Therefore, the bandwidth limitations for fEOMs are likely to come from the elections. In some embodiments, a high-power RF switch with a rise time of 3-5 ns may be used. In some embodiments, to avoid limitations in the RF switch speed, the RF waveform may be directly generated using a fast AWG. For example, a pulse at 0.1 ns would include a full-period sine function with a frequency of 10 GHz, corresponding to a sampling rate of at least 50 GSa/s.

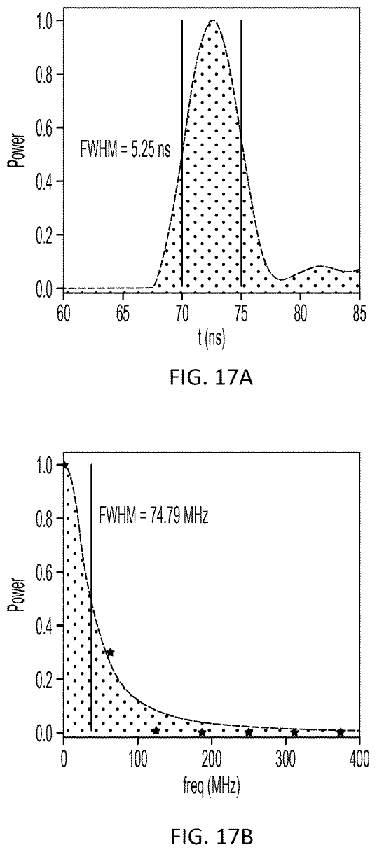

FIGS. 17A and 17B illustrate the performance of the fEOM system show in FIG. 16, in accordance with some embodiments of the technology described herein. To evaluate the performance of the fEOM system, a TTL pulse with 5 ns width is generated and used to control the high-power RF switch. As this is approaching the limit of the RF switch, the rise and fall take a finite time to complete rather than a square pulse. The resulting peak is recorded with a fast photodiode such as Thorlabs APD430.

FIG. 17A illustrates the RF pulse recorded by the photodiode, in accordance with some embodiments of the technology described herein. As shown in FIG. 17A, the pulse has a FWHM of 5.3 ns due to the speed limitations of the RF switch.

FIG. 17B illustrates the Fourier transform of the pulse show in FIG. 17A. As shown in FIG. 17B, the spectral components have a FWHM in the frequency domain of 74.8 MHz. The power of the pulse has a CW value up to 500 mW.

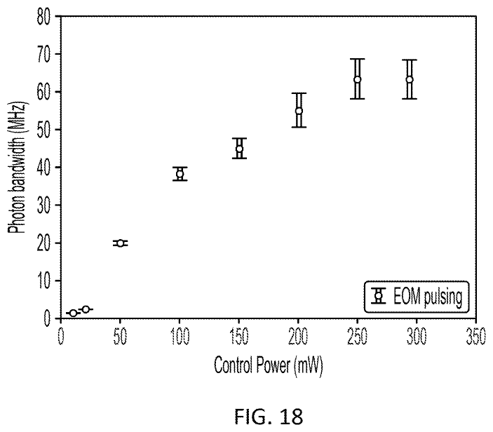

FIG. 18 illustrates the photon bandwidth as a function of control field power, in accordance with some embodiments of the technology described herein. Based on the plot of the photon bandwidth, the suitable photon bandwidth of memory operation is between 0-70 MHz.

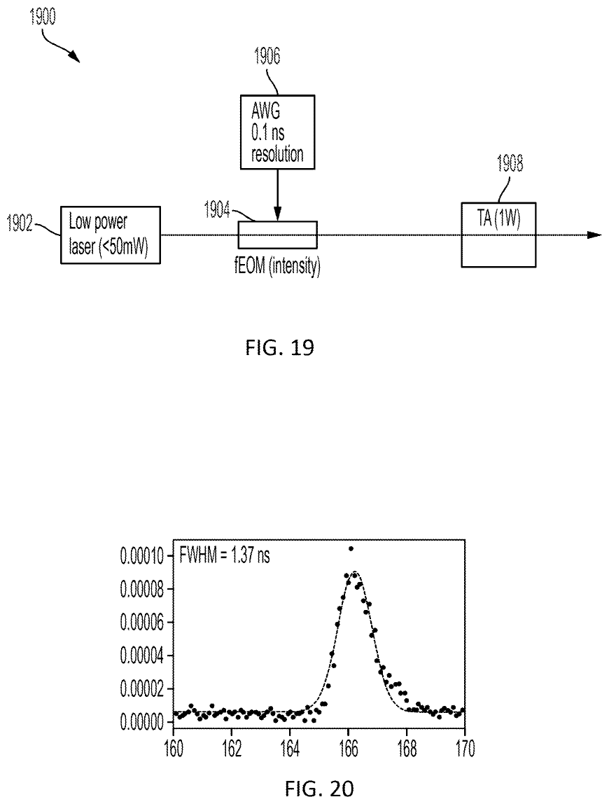

FIG. 19 illustrates an example of a lower power EOM intensity switching configuration 1900 with optical amplification, in accordance with some embodiments of the technology described herein. EOMs on waveguides may be used to avoid the use of demanding electronics driving requirements and to provide larger switching bandwidths. EOMs on waveguides may be implemented packaged in fiber-coupled configurations (fEOM). As with the fEOM described in FIG. 16 for phase modulation, fEOMs for intensity modulation provide for larger field strengths with smaller input voltages. The fEOM intensity modulator includes a Mach-Zehnder interferometer (MZI) with a phase modulator on one of its arms (or on both arms). Modulating the phase over 0-2π leads to complete constructive/destructive light interference on the exit port. Thus, the phase modulation through the interferometer is converted into intensity modulation.

Low power EOM intensity switching configuration 1900 includes lower power laser 1902, fEOM 1904, AWG 1906, and TA 1908. In some embodiments, low power laser 1902 generates light having less than 50 mw and transmits the light to fEOM 1904. AWG 1906 generates a pulse to drive the fEOM to modulate the intensity of the light received from laser 1902. After modulation by the fEOM, the modulated light is amplified by TA 1908.

The transfer function between the applied electric signal and optical output is a sine² function. Therefore, an electric signal in the range of −V_{π} to V_{π} generated on a fast time scale is used to generate a short pulse. The low power optical pulse (approximately a few mW) is amplified by a TA to a few watts. Unlike phase modulators, the intensity modulators does not generate extra frequency components. Accordingly, the filtering components may not be needed to isolate the amplified signal.

To generate a pulse with high contrast, the off-state should correspond to V_{π}+V_{O} and the on-state should correspond to V_{O}. In some embodiments, depending on the fEOM construction, the transfer function cannot be adjusted. In some embodiments, a DC bias can be applied to shift the voltage offset and shift the transfer function. For example, a fast programmable DAC may be used to control the transfer function. As another example, off-the-shelf fast AWGs may be used to control the transfer function.

FIG. 20 illustrates an example of a pulse generated using an intensity modulator and TA, in accordance with some embodiments of the technology described herein. To generate the plot in FIG. 20, a 10 GSa/s AWG from Tektronix (7101) operated in normal mode. The normal mode produces-2 to 2V functions with a 350 ps rise time. A Jenopik (AM795) intensity modulator was used with an extinction voltage of 1.5V. The resulting pulse, shown in FIG. 20, has a FWHM of 1.37 ns. The pulse size may be limited in this configuration based on the modulator response (approximately 200 ps) and the AWG rise time (350 ps). If an intensity modulator which included external CD bias, such as an iXblue intensity modulator, the modulator could be driven with the AWG direct mode, rather than the normal mode. The direct mode having a 70 ps rise time for a −1 to 1V function. Accordingly, pulses down to 0. Ins are supported by such a configuration.

The inventors have recognized and appreciated that because atomic noise processes have an associated time scale, tuning the bandwidth of the retrieved qubit, through appropriate preparation of the control laser, may temporally filter the retrieved qubit from the noise.

FIG. 21A is an example of the memory fidelity in the high-bandwidth regime, using fEOM with phase modulation and TA amplification, in accordance with some embodiments of the technology described herein. To improve the signal to noise of retrieved qubits, the target bandwidth for the retrieved may be determined based on the noise profile such that the signal to noise may be increased. For example, atomic noise process, such as four-wave mixing (FWM) and spontaneous Raman scattering (SRS) typically have a time scale that depends on the excited state lifetime since it includes a spontaneous process. For the DI transition in Rb, the time scale is approximately 27.7 ns. By preparing the control laser to produce retrieved qubits having a bandwidth higher than the timescale of the noise (e.g., only a few nanoseconds) the mismatch between the retrieved qubit and the noise provides for a degree of temporal separation between the noise signal and the qubit, as shown in FIG. 21A. FIG. 21A shows the retrieved qubit signal as a dashed trace and the noise as a solid trace. The retrieved qubit signal quickly reaches its peak while the noise signal is still slowly rising. As a result, an SNR up to 41 is achieved, corresponding to a fidelity of 98% in a polarization-agnostic setting. The storage efficiency was 6/8% The storage and retrieval reflected by FIG. 21A, contained an average of <n>=0.2 photons. To obtain the noise signal, shown in the solid line, the experiment is conducted with the input photon blocked. The results are multiplied by a factor of 5 for earlier visualization. The vertical lines mark the detection window with a 5 ns width.

FIG. 21B illustrates an example plot of the bandwidth of a qubit retrieval process, in accordance with some embodiments of the technology described herein. As shown in FIG. 21B, the bandwidth can reach sub-Ins, which helps improve signal-to-noise by avoiding the FWM noise. A nonlimiting explanation of the improvement in the SNR is that the retrieval process is first-order process and FWM is second-order process. Therefore, the retrieval takes place sooner than the rise of the noise.

As shown in FIG. 21B, the dashed line is the memory retrieval signal, the orange line is the noise signal (e.g., a measurement taken where there is no photon stored/retrieved). FIG. 21B shows the dashed line rising faster than the solid line, resulting in favorable results for SNR (e.g., by integrating signal collection during the area between the vertical lines). The collisional fluorescence is automatically avoided (the slow decaying tail to the right of the vertical lines).

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

The phrase “and/or,” as used herein in the specification and in the claims, should be understood to mean “either or both,” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “substantially,” “approximately,” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

1. A method for improving storage of optical qubits in an atomic vapor, the method comprising:
preparing a control laser pulse to store an optical qubit using a hot atomic vapor system, the optical qubit having a bandwidth, wherein preparing the control laser pulse comprises:
generating the control laser pulse having a bandwidth based on a temporal profile of the optical qubit; and
adjusting a pulse energy of the control laser pulse based on the temporal profile of the optical qubit;
transmitting the control laser pulse through the hot atomic vapor system to modify transmission properties of the atomic vapor; and
receiving the optical qubit at the hot atomic vapor system during the transmission of the control laser pulse through the hot atomic vapor system.

2. The method of claim 1, wherein adjusting the bandwidth of the control laser pulse based on the temporal profile of the optical qubit comprises modulating a source of the control laser pulse to adjust the bandwidth of the control laser pulse.

3. The method of claim 2, wherein a fiber-coupled electro-optical modulator is used to modulate the source of the control laser pulse.

4. The method of claim 1, wherein the bandwidth of the control laser pulse is adjusted to have approximately a same temporal profile as the optical qubit.

5. The method of claim 1, wherein adjusting a pulse energy of the control laser pulse is further based on properties of the atomic vapor and a beam geometry of the control laser pulse.

6. The method of claim 5, further comprising adjusting the amplification of the pulse such that the pulse intensity of the control laser pulse at the atomic vapor results in a transparency window having a linewidth approximately the same as the bandwidth of the optical qubit.

7. The method of claim 5, wherein adjusting the pulse energy of the control laser pulse comprises amplification of the control laser pulse after adjusting the bandwidth of the control laser pulse.

8. The method of claim 1, wherein the atomic vapor comprises a Rubidium atomic vapor.

9. The method of claim 8, wherein transmitting the control laser pulse through the hot atomic vapor system modifies a three-level system of the Rubidium atomic vapor producing a transparency window.

10. The method of claim 9, wherein the transparency window has a bandwidth between 10 and 100 GHz.

11. A method for controlling a bandwidth of optical qubits retrieved from an atomic vapor storage, the method comprising:
determining a target bandwidth for a retrieved optical qubit;
preparing a control laser to retrieve a stored optical qubit from a hot atomic vapor system such that the retrieved optical qubit has the target bandwidth;
transmitting the control laser through the hot atomic vapor system to modify transmission properties of the hot atomic vapor system;
receiving the retrieved optical qubit form the hot atomic vapor system in response to the control laser; and
isolating the retrieved optical qubit from the control laser.

12. The method of claim 11, wherein the control laser is prepared to produce the retrieved optical qubit having a same bandwidth as the previously stored optical qubit.

13. The method of claim 11, wherein the control laser is prepared to produce the retrieved optical qubit having a different bandwidth than the previously stored optical qubit.

14. The method of claim 11, wherein the target bandwidth of the retrieved optical qubit being based on a bandwidth of a second optical qubit, such as to improve an interference generated by interfering the retrieved optical qubit with the second optical qubit.

15. The method of claim 11, wherein preparing the control laser to retrieve the stored optical qubit from the hot atomic vapor system, such that the retrieved optical qubit has the target bandwidth, comprises modulating the control laser using a fiber-mounted electro-optic modulator.

16. The method of claim 11, wherein preparing the control laser to retrieve the stored optical qubit from the hot atomic vapor system, such that the retrieved optical qubit has the target bandwidth, comprises modulating the control laser using an acousto optic modulator.

17. The method of claim 11, wherein the atomic vapor comprises a Rubidium atomic vapor.

18. The method of claim 17, wherein transmitting the laser control pulse through the hot atomic vapor system modifies a three-level system of the Rubidium atomic vapor producing a transparency window.

19. A system for improving storage and retrieval of optical qubits stored in an atomic vapor, the system comprising:
a hot atomic vapor system comprising an atomic vapor;
a control laser configured to:
transmit a first control pulse having a bandwidth that is based on a bandwidth of an optical qubit to modify transmission properties of the hot atomic vapor system; and
transmit a second control pulse having properties based on a target bandwidth for a retrieved optical qubit; and
an optical filtering system configured to isolate the retrieved optical qubit from the control laser, the optical filtering system comprising:
a first etalon configured in a first double pass configuration, the first etalon having a first bandwidth; and
a second etalon configured in a second double pass configuration, the second etalon being positioned to receive an output of the first etalon, and the second etalon having a second bandwidth, wherein the second bandwidth is different from the first bandwidth.

20. The system of claim 19, wherein:
the first etalon receives light output from the hot atomic vapor system, and the first etalon is configured with a first polarizing beam splitter such that light returning from a double pass through the first etalon and a waveplate is directed to the second etalon; and
the second etalon is configured with a second polarizing beam splitter such that light returning from a double pass through the second etalon is directed to a detector.
